(19) United States
(12) Patent Application Publication
(10) Pub. No.: US 2006/0274052 A1
(43) Pub. Date: Dec. 7, 2006

(54) Electronic device with a touch display

(75) Inventors: Chien-Sheng Lo, Taipei (TW); Yu-Yuan Chen, Taipei (TW); Hung-Cheng Lee, Taipei (TW); Ying-Chi Chou, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/431,566

(22) Filed: May 11, 2006

(30) Foreign Application Priority Data
Jun. 6, 2005 (TW) 94118649

(51) Int. Cl. G09G 5/00

(52) U.S. Cl. 345/173

(57) ABSTRACT

An electronic device with touch display is disclosed. The electronic device includes a host, a main display apparatus and a touchable display apparatus. The main display apparatus is connected with the host via a joint structure which is able to make the main display apparatus and the host fold against each other and the display apparatus rotate on the host. The touchable display apparatus is installed on the host. When the display function of the touchable display apparatus is disabled, the touchable display apparatus can be used as a touch pad for the host; when the display function of the touch display apparatus is enabled, the touch display apparatus displays the same contents as the display apparatus.

### RELATED APPLICATIONS

The present application is based on, and claims priority from, Taiwan Application Serial Number 94118649, filed Jun. 6, 2005, the disclosure of which is hereby incorporated by reference herein in its entirety.

### BACKGROUND

1. Field of Invention

The present invention relates to an electronic device with an image display function. More particularly, the present invention relates to an electronic device with a touchable display apparatus.

2. Description of Related Art

A display apparatus used to display images an important element in many kinds of modern electronic devices. The data processed by an electronic device should be shown on the display apparatus in a format that can be understood by humans and provide access to useful information. For example, video data captured and processed by a digital camera should be shown on a display apparatus in a digital picture format, and various forms of digital data; such as characters, diagrams or images; stored in a personal computer (PC) or personal digital assistant (PDA) should be shown on a display apparatus that any human can interpret and understand.

Therefore, the display apparatus is continuously improving so that modern display apparatus have better image display qualities and are easier to carry than older display apparatus. For example, a monochrome display apparatus with a low image quality developed into a color display apparatus with a high image quality, and a bulky cathode ray tube (CRT) display apparatus developed into a light, thin liquid crystal and plasma display apparatus. Because the volume of the display apparatus can be effectively reduced, many kinds of electronic devices, like laptops and PDAs, can be miniaturized.

In some kinds of electronic devices, the display apparatus can be folded with the host reduce the overall space of the whole electronic device, and the display apparatus may further be rotated on the host for increasing the visible scope of the image and decrease the move of the electronic device. For example, the display apparatus of a tablet PC developed from a laptop not only can be folded with the host of the tablet PC but can also be rotated on the host so that the information and the image shown on the display can be readily seen by other users.

When the display apparatus in the tablet PC is rotated at more than a certain angle, the user operating the tablet PC will not see the information and image shown on the display apparatus. At this time, the display apparatus needs to be frequently rotated back to the original position, and apart from being an inconvenience to the user, the user will waste much time rotating the display apparatus. Hence, an apparatus for immediately displaying the screen contents to the user is needed.

### SUMMARY

It is therefore an objective of the present invention to provide an electronic device with an auxiliary display apparatus for operating conveniently.

It is another objective of the present invention to provide an electronic device with a touchable display apparatus.

It is still another objective of the present invention to provide a laptop or tablet PC with a framework of a display apparatus combining a touch pad.

It is another objective of the present invention to provide a more practical laptop or a tablet PC system.

According to the foregoing objectives of the invention, the electronic device according to an embodiment of the present invention comprises a host, a main display apparatus and a touchable display apparatus. The main display apparatus is connected to the host through a joint structure, and the joint structure allows the main display apparatus to fold against the host and rotate relative to the host. The touchable display apparatus is installed on the host, when the display function of the touchable display apparatus is enabled, the touchable display apparatus display the same image as the main display apparatus.

Any type of switch that can enable and disable the display function of the touchable display apparatus may be implemented. For example, the switch may be an independent switching mechanism or a hot key preset in the host. The switch may be further combined into the joint structure connecting the main display apparatus and the host. When a predetermined rotating angle between the main display apparatus and the host is reached, the switch automatically enables the display function of the touchable display apparatus. When the main display apparatus and the host are folded against each other or in other conditions, the switch automatically disables the display function of the touchable display apparatus. In addition, the touchable display apparatus can be a touch pad of the host no matter if the display function of the touchable display apparatus is enabled or disabled.

### BRIEF DESCRIPTION OF THE DRAWINGS

These and other features, aspects, and advantages of the present invention will become better understood with regard to the following description, appended claims, and accompanying drawings, where:

FIG. 1A is a schematic diagram of a tablet PC showing one preferred embodiment of the present invention; and

FIG. 1B is another schematic diagram of a tablet PC showing one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Many kinds of advanced electronic devices, such as a tablet PC, a PDA and a mobile phone, have a display apparatus attached to a host of the electronic devices that can be rotated at random to increase the visible angle of the image. The basic concept of the preferred embodiment of the present invention is to install a touchable display apparatus on the electronic device, so that the touchable display apparatus is able to display the same contents as the main display apparatus of the electronic device. Thus, when a user operates the electronic device, the contents displayed on the main display apparatus can be immediately confirmed by the user operating the electronic device without frequently moving the electronic device.

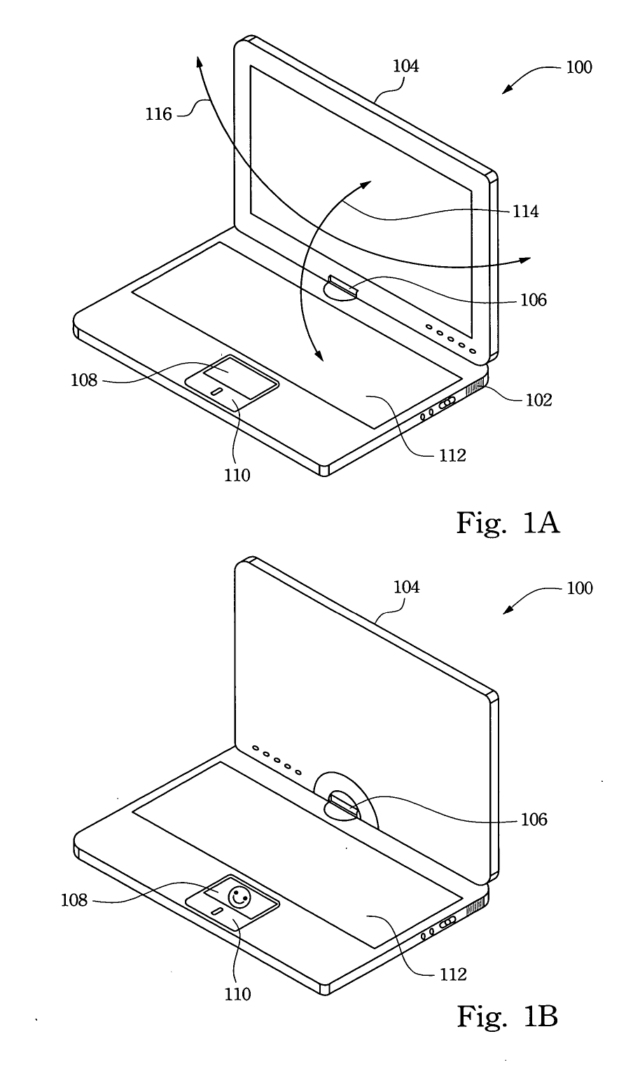

Referring to FIG. 1A, a tablet PC 100 is shown to represent the electronic device according to an embodiment of the present invention. The tablet PC 100 includes a host 102, a main display apparatus 104 and a joint structure 106 connecting the host 102 and the main display apparatus 104. In addition, the host 102 is electrically connected to the main display apparatus 104. Therefore, the host 102 used to process and output various data can output the processed data to the main display apparatus 104 for displaying. The main display apparatus 104 displays an image that corresponds to the video data outputted from the host. In this embodiment, the main display apparatus 104 can be a liquid crystal display (LCD), plasma display or organic light emitting diode (OLED) display.

In the tablet PC 100, there is not only a signal connection but also a structural connection between the host and the main display apparatus 104. In this embodiment, a joint structure 106 is used to structurally connect the host 102 and the main display apparatus 104. The joint structure 106 allows the host 102 and the main display apparatus 104 to fold against each other along a direction 114, and the main display apparatus 104 can further be rotated on the host 102 in the direction 116. Thus, the user of the tablet PC 100 not only can open the tablet PC 100 along the direction 114 for normal operation but also can share the information displayed on the main display apparatus 104 to other users by rotating the main display apparatus 104 in the direction 116 (as shown in FIG. B).

When the main display apparatus 104 is rotated to a predetermined angle such as 90 degrees, the user of the tablet PC 100 will be unable to see the contents displayed on the main display apparatus 104 and be unable to further operate the tablet PC 100. In an embodiment of the present invention, a touchable display apparatus 108 is installed on the host 102 to resolve above problem. The touchable display apparatus 108 may be any kind of display apparatus and can accept any data which the main display apparatus can receive, so that the main display apparatus 104 and the touchable display apparatus 108 can display the same image. The touchable display apparatus 108 may be smaller than the main display apparatus 104 in size. In this embodiment, the touchable display apparatus 108 is installed on the surface of the host 102 and electrically connected to the host 102. Thus, the user can monitor the image displayed on the main display apparatus 108 any time via the touchable display apparatus 108.

Furthermore, the touchable display apparatus 108 not only can display the contents on the main display apparatus 104 but can also be used as a touch pad. That is to say, a user can operate an input function that a mouse can provide or operate a data inputting function through the touchable display apparatus 108 to the host 102 directly carried with a finger or a predetermined tool, such as a touch pen. Inputted data may be cursor position control or using handwriting to input characters. Thus, the user can use the touchable display apparatus 108 to see the image displayed on the main display apparatus 104 and control the host 102 at the same time. In this embodiment, the touchable display apparatus 108 may be a touch screen.

Furthermore, at least one control button 110 may be implemented around the touchable display apparatus 108 to be operated in coordination with the touchable display apparatus 108. The control button 110 can be used as the button on a conventional mouse for more cursor controlling operations. Besides, the touchable display apparatus 108 may be integrated with the touch pad of a conventional laptop or tablet PC so that the two functions of displaying and cursor controlling can be implemented with the same electronic element.

The display function of the touchable display apparatus 108 can be synchronously enabled and disabled with the main display apparatus 104 in the basic design, but it is not-economical in terms of energy efficiency. Therefore, a switch used to manually enable and disable the touchable display apparatus 108 may be installed in the tablet PC 100, or a hot key to manually enable and disable the touchable display apparatus 108 may be preset on the keyboard 112 of the host 102 with a setup program.

In an embodiment of the present invention, the switch is combined into the joint structure 106. When the main display apparatus is rotated along the direction 116 to the predetermined angle, the switch in the joint structure 106 is switched to enable the display function of the touchable display apparatus 108. Referring to FIG. 1B, when the rotated angle of the main display apparatus 104 reaches 180°, the display function of the touchable display apparatus 108 is automatically enabled. Under other conditions, such as the host 102 and the main display apparatus are folded against each other or the rotated angle of the main display apparatus does not reach the predetermined angle, the display function of the touchable display apparatus 108 is automatically disabled. In addition, the function of touching and controlling of the touchable display apparatus may always be enabled, even if the display function is disabled.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic device with touch display, comprising:
a host outputting video data;
a main display apparatus displaying an image according to the video data;
a joint structure connecting the host and the main display apparatus so that the main display is rotated relative to the host; and
a touchable display apparatus electrically connected to the host and displaying the same image with the main display apparatus.

2. The electronic device with touch display as claimed in claim 1, wherein the electronic device is a tablet personal computer (tablet PC), a personal digital assistant (PDA) or a mobile phone.

3. The electronic device with touch display as claimed in claim 1, further comprising a control button for operating in coordination with the touchable display apparatus to control a cursor shown in the image.

4. The electronic device with touch display as claimed in claim 1, further comprising a switch for controlling whether the touchable display apparatus displays the image or does not display the image.

5. A tablet personal computer (tablet PC) with touch display, comprising:
a host outputting video data;
a main display apparatus displaying an image according to the video data;
a joint structure connecting the host and the main display apparatus so that the main display is rotated relative to the host; and
a touchable display apparatus electrically connected to the host and displaying the same image with the main display apparatus,
wherein the touchable display apparatus displays the image when the rotated angle of the main display apparatus reaches a predetermined angle.

6. The tablet PC with touch display as claimed in claim 5, further comprising a control button for operating in coordination with the touchable display apparatus to control a cursor shown in the image.

7. The tablet PC with touch display as claimed in claim 5, further comprising a switch for controlling whether the touchable display apparatus displays the image or does not display the image.

8. The tablet PC with touch display as claimed in claim 7, wherein the switch disables the display function of the touchable display apparatus when the main display apparatus and the host are folded against each other.
